(19) United States
(12) Patent Application Publication
(10) Pub. No.: US 2021/0001480 A1
(43) Pub. Date: Jan. 7, 2021

(54) Autonomous Mobile Robot And Method For Controlling An Autonomous Mobile Robot

(71) Applicant: Robart GmbH, Linz (AT)

(72) Inventors: Harold Artes, Linz (AT); Erwin Mascher, Linz (AT); Vladimir Alexandrov, Linz (AT)

(73) Assignee: Robart GmbH, Linz (AT)

(21) Appl. No.: 16/472,524

(22) PCT Filed: Dec. 22, 2017
(86) PCT No.: PCT/AT2017/060346

§ 371 Date: Jun. 21, 2019

(30) Foreign Application Priority Data
Dec. 22, 2016 (DE) 10 2016 125 408.8

(51) Int. Cl. B25J 9/16

(52) U.S. Cl. CPC B25J 9/163; B25J 9/161; B25J 9/1697; B25J 9/1666

(57) ABSTRACT

An autonomous mobile robot is described having a propulsion module designed to move the robot in its surroundings, a control module designed to transmit control commands to the propulsion module, the control commands being designed to control the movement of the robot, and a security module designed to detect a dangerous situation, classing an actual movement of the robot as dangerous on the basis of predetermined criteria, and to change or stop the movement of the robot when the movement is classed as dangerous.

### TECHNICAL AREA

The embodiments described here relate to an autonomous mobile service robot such as, e.g. a robot for processing a surface (cleaning of floors), for transporting objects or for monitoring and inspecting an area, as well as a method for controlling such an autonomous mobile robot.

### BACKGROUND

In recent years, autonomous mobile robots, in particular service robots, are being increasingly employed both in private households as well as in commercial environments. Autonomous mobile robots can be employed, for example, to clean floors, to monitor buildings, to enable communication independent of location or current activity or to transport objects.

For these purposes, autonomous mobile robots are generally equipped with sensors, for example laser scanners, ultrasonic sensors or tactile sensors in order to detect obstacles in the area and avoid collisions, e.g. with people or objects. Sensors are known that are directed towards the floor in order to detect potentially dangerous ledges (e.g. steps) and prevent the robot from falling off them, as such a fall could cause damage to both the robot and any object located nearby. Also people could be endangered by a falling mobile robot. By detecting the environment using the sensors and subsequently analyzing the detection data, the robot is able to recognize in advance potential dangers and avoid accidents by adapting its movements to the detected dangerous situation.

With the aspiration to develop and market ever more intelligent systems, the behavior routines used in autonomous mobile robots also become increasingly more complex. As in the case of many complex software applications, however, increasing complexity is also accompanied by a growing susceptibility to malfunctions. This means that, although the robot is equipped with sensors for detecting a dangerous situation, the control software may not react adequately to the detected dangerous situation due to a malfunction, an undetected programming error or undesired outside influences. As the functional control software becomes more complex, verifying that at robot will adequately and correctly react to all conceivable dangerous situations becomes increasingly difficult. Verifying functional safety, however, may be needed for certain applications to fulfill legal stipulations. Functional safety requirements are also the subject of various standards (e.g. EN/IEC 61508 and EN/EIC 62061).

The underlying technical problem of the invention can thus be seen, inter alia, as providing a robust safety mechanism for autonomous mobile robots that can reliably and verifiably recognize and avoid dangerous situations.

### SUMMARY

The aforementioned problem is solved with an autonomous mobile robot in accordance with claim 1, as well as by means of a method in accordance with claim 26. Various embodiments and further developments are the subject matter of the dependent claims.

An autonomous mobile robot is described. In accordance with one embodiment the robot comprises a drive module configured to move the robot through an environment, a control module configured to send control commands to the drive module, the control commands being configured to control the movement of the robot, and a safety module that is configured to detect a dangerous situation by assessing, using specified criteria, a current movement of the robot to be dangerous and to alter or stop the robot's movement if the movement is assessed to be dangerous.

Further, a method for controlling an autonomous mobile robot is described. In accordance with one embodiment, the method comprises controlling a movement of the robot using a control module, wherein controlling the movement comprises the sending of control commands to the drive module by the control module, wherein the drive module is configured to move the robot through an environment. The method further comprises detecting a dangerous situation by means of a safety module, assessing the current movement of the robot to be dangerous in accordance with specified criteria when a dangerous situation has been detected and altering or stopping the movement of the robot (100) by the safety module if the movement is assessed to be dangerous.

### SHORT DESCRIPTION OF THE DRAWINGS

In the following the invention will be described in greater detail based on the example illustrated in the figures. The illustrations are not necessarily true to scale and the invention is not limited to the illustrated aspects. Instead importance is given to illustrating the underlying principles of the invention. The figures show:

FIG. 1 shows examples of various autonomous mobile robots, as well as various possible dangerous situations.

FIG. 2 is a block diagram showing an example of an autonomous mobile robot.

FIG. 3 shows, in the form of a flow chart, a method for controlling an autonomous mobile robot.

FIG. 4 is plan view from below of the underside of an exemplary autonomous mobile robot.

### DETAILED DESCRIPTION

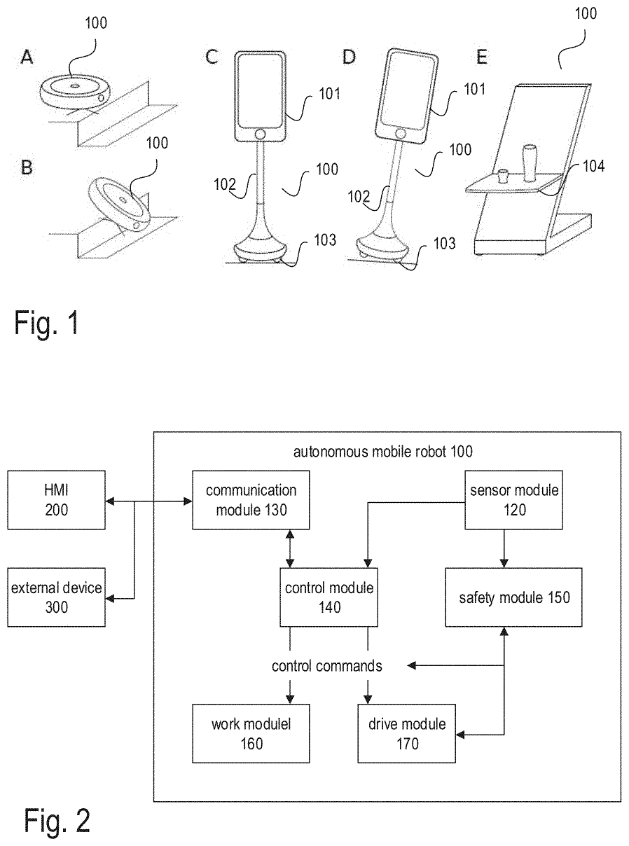

FIG. 1 illustrates various examples of an autonomous mobile robot 100, as well as possible dangerous situations. FIG. 1A illustrates, for example, a vacuuming robot that is configured to clean floors, specifically, to vacuum. The vacuuming robot generally moves about on at least three wheels (not shown in FIG. 1A). Rotating brushes or similar are generally arranged on the underside of the vacuuming robot to gather dirt while the robot 100 moves across the floor surface. The vacuuming robot could be damaged by, for example, by falling off a stair step, as shown in FIG. 1B. The floor surface, nearby objects or people may also suffer damage or harm if the robot 100 drops on them or collides with them. Some autonomous mobile robots 100 therefore have floor clearance sensors (not shown in FIG. 1) that can timely recognize dangerous ledges such as, for example, a stair step in order to avoid falls. Floor clearance sensors are also sometimes referred to as floor detection sensors or, in short, as floor sensors.

FIG. 1C shows an example of a telepresence robot. A telepresence robot usually comprises an interface (101, also called a Human Machine Interface HMI) such as, for example, a display, a smartphone, a tablet or similar. This interface 101 is attached to an upper end of a vertical arm 102 of the robot 100. A robot body with a drive module 103 is attached to the lower end of the vertical arm 102. The drive module 103 may comprise, for example, one or more motors and two or more wheels, by means of which the telepresence robot can move forward. A telepresence robot generally serves to enable simple communication independent of the location or current activity of the user, to which end the robot 100 can independently follow the user. Due to the slim construction design of the robot 100 and the interface 101 attached to the upper end of the vertical arm 102, such a telepresence robot has relatively elevated center of gravity. As a rule the robot can keep its balance on its own. However, when moving across steeply inclined surfaces, for example, the robot 100 can easily tilt, which may damage the apparatus. An overly rapid acceleration or moving over thresholds or steps may also cause the robot 100 to tilt. The surrounding floor surface, object located nearby or people may be damaged or harmed if the robot 100 tilts or tips over. A tilting of the telepresence robot is exemplarily illustrated in FIG. 1D. Telepresence robots may therefore have sensors (not shown in FIG. 1) that are configured to determine the position (in particular the inclination), the acceleration and/or the angular velocity of the robot 100. Telepresence robots may also have sensors that are configured, for example, to detect thresholds (e.g. door thresholds) in order to appropriately adapt the movement of the robot and thus prevent the robot from tilting.

FIG. 1E shows an example of an assistance robot, in particular a transport robot. A transport robot has a transport platform 104, on which objects to be transported, e.g. plates or glasses, can be placed. On its underside the transport robot has, for example, wheels (not shown in FIG. 1E), by means of which it can move about. Such robots may be able to, for example, help elderly people carry out daily tasks and thus enable them to lead an independent life. Transport robots may also be employed in nursing homes to provide support to the nursing staff with their work. There are many other conceivable areas of employment for transport robots (for example, in warehouses, restaurants, etc.). In the case of transport robots, it is generally important to ensure a slow acceleration in order that objects placed on the transport platform 104 do not tip over or become misplaced. For example, sensors (not shown in FIG. 1E) can be arranged near the transport platform 104 that determine the weight of the object to be transported. Sensors may also be used to determine what sorts of objects are located on the transport platform 104. Avoiding collisions remains essential in order to prevent the transported objects or the entire robot 100 from tilting. For this purpose the robot 100 can be provided with numerous different types of sensors (if needed with corresponding signal processing) that are configured to detect objects or people standing or moving in the robot's 100 environment (for example, laser range finders, optical triangulation sensors, cameras, etc.).

Thus it is, in general, possible for the robot to move autonomously through its area of deployment by making use of various methods and techniques to detect situations that may possibly be dangerous for autonomous mobile robots 100 and to adequately react to a detected dangerous situation, (meaning avoiding accidents or at least mitigating their effects). Such robots 100 generally have a control software for controlling the autonomous mobile robot 100. However, similar control software, executed by a processor in a control module, is becoming ever more complex. Together with the growing complexity of the control software, the risk of unintended programming errors also increases. An increasing number of autonomous mobile robots 100 can also access the Internet. This enables the robot 100, for example, to be controlled and monitored even when the user is not in the vicinity of the robot 100. In addition, the firmware, in particular the control software of the robot 100, can be updated via Internet. For example, a software update can be downloaded automatically or upon request of the user. This functionality is also known as Over the Air Programming (OTA Programming), OTA Upgrading or Firmware Over the Air (FOTA).

Connecting an autonomous mobile robot 100 to the Internet, however, can also create the risk that unauthorized persons may obtain access to the robot 100 (e.g. so-called hacking, cracking or jail breaking of the robot) and thus prevent the robot from correctly reacting in dangerous situations, possibly causing accidents. The entire software can be stored in the robot 100 itself, i.e. in a data storage device arranged within the robot. It is, however, also possible to store part of the software on external devices, e.g. on cloud servers. If parts of the control software are stored on external devices, parts of the robot 100 will generally not be able to operate in real time. Robots 100 are known whose control software employs non-deterministic Monte Carlo Methods or methods of machine learning (e.g. Deep Machine Learning). The name “Monte Carlo Algorithms” is used to designate randomized algorithms that, with a capped limit of probability, may produce a false result. Compared to deterministic algorithms, Monte Carlo algorithms are generally more efficient. “Deep Learning” generally refers to a class of optimization methods for artificial neuron networks that comprise numerous hidden layers between the input layer and the output layer and thus exhibit an extensive inner structure. Both in the case of Monte Carlo algorithms, as well as in that of machine learning, cause and effect relationships are not determined in advance and are thus difficult to conclude. This renders it difficult to verify the safe functioning of the robot 100 and to guarantee that the control software of the robot 100 react to any given dangerous situation in time and correctly in order to avoid an accident. At the same time, employing this kind of new robot control software is necessary in order to make autonomous mobile robots 100 more intelligent. Heightened intelligence makes it easier for the robot 100 to integrate itself into the life of the concerned user and into its respective environment.

It may therefore be important or even necessary to enable a verifiably safe behavior of the robot without, however, limiting the robot's 100 intelligence. In accordance with one embodiment, the autonomous mobile robot 100 has a safety module 150, which may also be called a risk detection module, in addition to the control module (in which the aforementioned control software is executed). This is exemplarily illustrated in the block diagram of FIG. 2. In the examples described here, the safety module 150 operates independently of the control module 140. Basically the safety module 150 is configured to monitor the robot behavior independently of the control module and to recognize dangerous situations. If the behavior of the robot in a detected dangerous situation is assessed to be wrong, dangerous or inadequate, the safety module 150 can initiate counter measures (safety measures). Counter measures may consist, for example, in stopping the robot 100 or in altering the robot's 100 direction of movement. Here advantage is taken of the fact that, as a rule, it is easier to determine what movement may not be carried out, because it is unsafe, than it is to determine, what movement is the correct one.

In accordance with the example illustrated in FIG. 2, the robot 100 may also have numerous other modules. Each of these modules may generally comprise a discrete assembly (hardware), a component of a software for controlling the robot 100 as it carries out a desired task in a given area of robot deployment, or a combination of the two (e.g. dedicated hardware with connected peripheral components and the corresponding software and/or firmware). The software (control software) responsible for the robot's 100 behavior can be run in a control module 140 of the robot 100 (by means of a processor that executes the control software and by those of a memory in which the control software is stored). This processor may, e.g. be contained within a microcontroller. The control software may also be at least partially run on an external device 300 (e.g. personal computer, server, etc.), that can be accessed, for example, via a home network (e.g. a LAN or WLAN) or over the Internet (Cloud). The control module 140 can possess all the functionalities needed to enable the autonomous mobile robot 100 to move independently throughout its area of deployment and carry out tasks. When, in the process, certain operation steps or parts of operation steps are carried out “by the robot”, it is not absolutely necessary that the entire operation step or the entire partial operation step be exclusively completed by the hardware and software located within the robot. It is also possible for the robot 100 (generally the control module 140 of the robot) to only initiate the execution of the operation step or the partial operation step and that the operation step or partial operation step be actually completed by external hardware and/or software (e.g. by an external computer or server 300 that communicates with the robot via a data link). It should further be noted that the “intelligence” of the robot may also be distributed among the various modules of the robot and need not necessarily be concentrated in a central control module. When a given operation step or partial step is carried out “by the robot”, the operation step or partial step can actually be carried out by one module of the robot (e.g. the control module 140), by numerous modules collectively and/or with the aid of external hardware and software.

The control module 140 is configured to generate control commands for a drive module 170 and/or a work module 160 based on information provided by a sensor module 120 and/or a communication module 130. In addition to this, the control software may include functions for recognizing objects and for work planning Further, the control module 140 can be configured to recognize dangerous situations based on the information provided by the sensor module 120 and to generate appropriate control commands to avoid or mitigate the effects of the dangerous situation. In the present example the autonomous mobile robot 100 comprises a drive module 170 which, for example, may have electromotors, transmissions and wheels. With the aid of the drive module 170 the robot 100 can—theoretically—access any point in its area of deployment. The robot 100 may also have a communication module 130 for establishing a communication link to a human machine interface 200 (HMI) and/or to any other external devices 300. The communication link may be, for example, a direct wireless link (e.g. Bluetooth), a local wireless network connection (e.g. WiFi or Zig-Bee) or an Internet connection (e.g. to a cloud service). The human machine interface 200 can provide the user with information, for example, regarding the autonomous mobile robot 100 (e.g. battery status, current work task, map information, etc.) and can receive user commands, e.g. regarding a work task of the autonomous mobile robot 100. Examples of human machine interfaces 200 include tablet PCs, smart phones, smart watches, computers or smart TVs. In some cases the human machine interface 200 may also be directly integrated in the robot 100 and operated using keys, gestures or vocal input and output. The aforementioned external hardware and software may be at least partially located in the human machine interface 200. Examples of external devices include computers and servers to which data can be sent for storage, external sensors that provide additional information or other household devices (e.g. other robots) with which the autonomous mobile robot 100 collaborates and exchanges information.

The robot 100 may also possess a work module 160 (process module) that carries out certain processes such as, e.g. the cleaning of a floor surface or the transport of objects. The work module, for example, may be a cleaning module for cleaning a floor surface (e.g. brushes, vacuuming device), a vertically adjustable and/or swiveling transport platform designed to serve as a tablet or a gripper arm for gripping and transporting objects. In some cases, as in those of a telepresence robot or a monitoring robot, a work module 160 is not necessarily needed. Such a telepresence robot generally possesses a complex communication module 130, coupled to human machine interface 200, with a multimedia unit consisting, for example, of a microphone, camera and screen (cf. FIG. 1, interface 101) to enable the communication between numerous spatially distant persons. Another example is a monitoring robot that, with the aid of a sensor module 120, can recognize certain (unusual) events (e.g. fire, light, unauthorized persons) while carrying out inspections and, for example, may inform a monitoring basis thereof.

In order to be able to autonomously carry out a task, the robot 100 may also optionally possess a navigation module with which it can orient itself in its environment. The navigation module may be part of the control module 140 and is therefore not explicitly illustrated in FIG. 2. To orient itself and to navigate, the navigation module can process navigation features (i.e. features that the robot can use to orient itself) such as, for example, land marks (e.g. items of furniture, door frames, the corners of a room, etc.) that can be identified with the aid of the sensor module 120 (i.e. detected and located) and can use these to navigate through the area of robot deployment. A similar navigation module may operate using, for example, a “Sense and Avoid Strategy” and/or a SLAM algorithm (Simultaneous Localization and Mapping) and/or one or more maps of the area of robot deployment. The map(s) of the area of robot deployment can be newly compiled by the robot during its deployment or the robot can make use of a map already existing at the beginning of its deployment. An already existing map may have been compiled by the robot itself, for example, during a previous deployment while carrying out an inspection run, or it may be provided by another robot and/or person and then, for example, permanently stored in a memory module (not shown in FIG. 2). A memory module frequently comprises a non-volatile memory (e.g. a Solid State Disk, SSD). As an alternative, maps of the area of robot deployment that are to be permanently saved can also be stored outside of the robot, for example, on a computer in the household of the robot's user (e.g. a tablet PC, a home server) or on a computer that is accessible via Internet (e.g. a Cloud server).

The sensor module 120 may have, for example, one or more sensors for detecting the environment of the robot 100 and/or for detecting the current status of the robot 100. For example, the sensor module 120 may have one or more sensors for measuring the distance to objects in the environment such as, for example, an optic and/or acoustic sensor that operates by means of triangulation or travel time measurement of an emitted signal (e.g. triangulation sensor, time-of-flight camera, laser scanner, ultrasonic sensors, etc.). Other typical examples of suitable sensors include camera for taking pictures of the environment, tactile sensors that react to a physical contact with an object, acceleration sensors, rotation rate sensors, odometers and/or the aforementioned floor clearance sensors. Floor clearance sensors can detect, for example, ledges over which the robot could fall off. Examples of sensors for detecting the current status of the robot 100 include current sensors for determining the condition of an actuator, in particular that of a motor, wheel contact sensors for determining whether the robot is in firm contact with the floor surface, position sensors for determining an inclination of the robot 100 or odometers such as, for example, sensors that measure wheel rotation (wheel encoders), as well as inertial sensors such as, for example, acceleration sensors and rotation rate sensors (combined, for example, in an inertial measurement unit (IMU) for detecting the movement of the robot 100.

Further, the autonomous mobile robot 100 may also have an energy supply such as a battery (not shown in FIG. 2). The battery can be charged, for example, while the autonomous mobile robot 100 is docked in a base station (not shown in the figures). The base stations may be connected, for example, to the electricity grid. The autonomous mobile robot 100 can be configured, for example, to independently travel to the basis station when the battery needs charging or after the robot 100 has completed all its tasks.

The safety module 150 is configured to monitor, autonomously and independently of the control module 140, selected safety-related aspects of the autonomous movement of the robot 100. The safety module 150 is further configured to intervene if the control module 140 fails to react or fails to adequately react to a dangerous situation. An inadequate reaction is a reaction that fails to avoid the dangerous situation or one that might create an additional dangerous situation. One such inadequate reaction may be, for example, a reaction that results in the robot 100 tilting or falling, which may render the continued operation of the robot 100 without human intervention impossible and which may cause damage to the robot, to objects in the environment, to the floor covering or harm to any people standing nearby. In order to achieve the aforementioned independence from the control module 140, the safety module 150 may have, for example, its own processor and memory module. For example, the safety module may be implemented as a separate component in the robot. A software for detecting dangers can be stored in the memory module and run by the processor. It may be possible for the safety module 150 to have its own, separate processor and its own, separate memory module. It may, however, also be possible for the safety module 150 to share a processor and a memory module with one or more of the other modules of the robot 100. In one embodiment, a processing unit of a processor may be assigned to the safety module 150 and its other processing units can be used by other modules (such as, e.g. the control module 140). For example, the control module 140 and the safety module 150 may share a processor. Despite this, the software of the safety module 150 can operate independently of the control module's 140 software or that of other modules. When the safety module 150 has its own processor and its own memory module (or when it exclusively uses a processing unit of a processor), this can help to reduce disturbing influences and more easily ensure that the responsible safety module 150 reacts reliably and timely in dangerous situations.

The software for detecting dangers can be of a very simple design in order to ensure a comprehensible, and thus verifiably reliable, detection of and reaction to dangerous situations. In accordance with one embodiment it is also possible for the autonomous mobile robot 100 to have numerous safety modules 150, each of these safety modules 150 being configured to detect specific dangerous situations with corresponding danger detection software that is specialized for such detection. It is, for example, also possible for various aspects and tasks of the safety module 150 to be implemented in hardware (i.e. without special software). This can help to ensure a speedy reaction to critical events.

One possibility for achieving the goal of rendering the safety module 150 and the danger detection software as simple as possible consists, for example, in applying various concepts of reactive and/or behavior-based robotics in the safety module 150. Such concepts define, for example, that the behavior of the robot 100 is determined only based on current sensor data of the sensor module 120. As opposed to such concepts, the safety module 150 is only configured to intervene in the control of the robot 100 in extraordinary situations, for example, if an imminent danger is detected to which the control module 140 does not adequately react. To this end, for example, prohibited, potentially dangerous movements that, without the intervention of the safety module 150, might lead to an accident are determined (based on current data provided by the sensor module 120). The safety module 150 is configured to intervene if the robot 100 carries out, or is instructed to carry out, such a prohibited or dangerous movement in order to prevent or alter the prohibited or dangerous movement. For example, the safety module 150 may be coupled to one or more floor clearance sensors (contained, e.g. in the sensor module 120). If a floor clearance sensor indicates an unusually large distance to the floor (e.g. because the robot is just about to move over a ledge or because the robot was just lifted up), the safety module 150 can assess this situation to be a dangerous situation. If the floor clearance sensor in question is arranged at the front of the robot (as defined by its direction of movement), the safety module 150 can judge the current movement to be dangerous and initiate a stop of the movement or its alteration (e.g. by reversing it). In this case the criteria that the safety module 150 applies when detecting a dangerous situation virtually the same as those applied by the safety module 150 when assessing the current movement (as dangerous or not dangerous). Thus, if a clearance sensor arranged at the front of the robot (as defined by its direction of movement) indicates an increased clearance, the situation is recognized as being dangerous and the current movement is judged to be dangerous; the safety module “overrules” the control module and causes the drive module to either stop or alter the current movement. If a certain type of dangerous situation is detected (e.g. when an imminent fall over a ledge is detected), the safety module can thus immediately stop the current movement of the robot (because virtually any continuation of the current movement must be assessed to be inappropriate and/or dangerous).

The control software of the autonomous mobile robot 100 can be configured to update itself via a connection to the communication module 130 (e.g. over the Internet / software update), or to add new functionalities via the same connection (software upgrade), thus expanding the range of possible deployments of the robot. An inherent risk present in every update or every upgrade, however, is that errors may also be thereby brought into the control software. In addition to this, connecting the robot 100, for example, to the Internet may open it up for possible attacks by third parties who in this manner may acquire unauthorized access to the robot, assume control of it and thus cause damage. For this reason, updating the danger detection software of the safety module 150 can only be carried out, for example, together with the implementation of additional security measures and/or only when absolutely necessary. This may include stipulating that no update of the danger detection software may be carried out at all, that the update may only be carried out over a wired communication interface or that an update may only be carried out after the source of the updated software has been authenticated (e.g. by exchanging software certificates). If both the danger detection software and the control software are only to be updated after the source of the update software has been authenticated, then, for example, different methods of authentication can be used for the danger detection software update and the control software update. Essentially, however, any suitable authentication method may be employed.

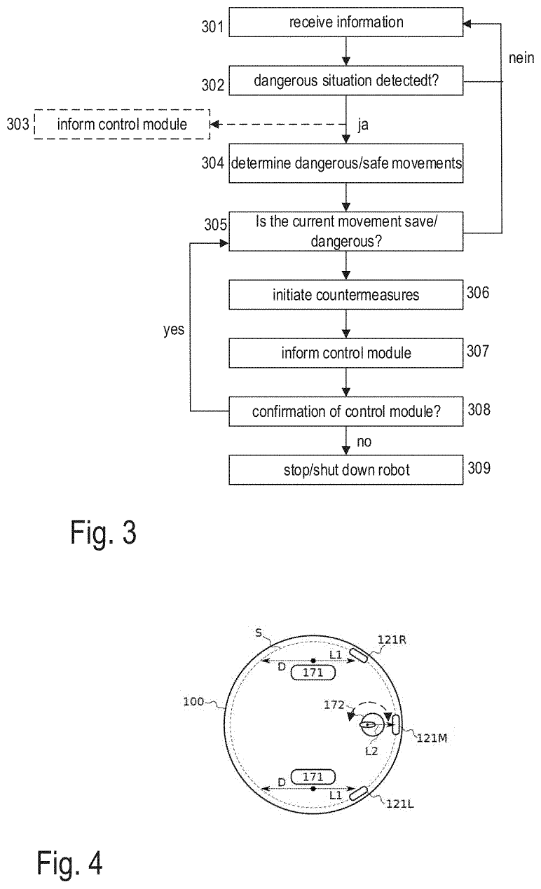

FIG. 3 shows the example of a method for controlling an autonomous mobile robot 100. In a first step 301 the safety module 150 can receive information. The information may be sent, for example, by the sensor module 120, wherein the information from the sensor module 120 may concern, for example, the internal state and/or the environment of the robot 100. Additionally or alternatively the safety module 150 may receive information concerning the control commands sent by the control module 140 to the drive module 170. It is, however, also possible for the safety module 150 to additionally or alternatively receive information from the drive module 170, wherein the information from the drive module 170 may concern, for example, the current movement (e.g. direction and speed) as well as the control commands received from the control module 140. Additionally or alternatively the safety module 150 may receive information concerning control commands sent by the control module 140 to the work module 160. The information may include, for example, information regarding the environment of the robot 100, e.g. the location of dangerous ledges, thresholds or obstacles or the movement of obstacles (e.g. people). The information received concerning the environment of the robot 100 may be coupled by the safety module 150 to information regarding a current movement or a planned movement of the robot 100. The information may be directly processed upon reception in the safety module 150 and/or it may be stored there for a specifiable time period or a specifiable distance (the distance travelled by the robot 100) before being processed.

In addition, the information received may pertain to map data regarding the environment of the robot 100 which, for example, may be compiled and maintained by the navigation module. The map data may contain, for example, information regarding dangerous ledges or other obstacles. Under normal operating conditions, the robot 100 knows where on the map it is currently located.

Based on the received information, the safety module 150 can verify whether a dangerous situation is present (step 302). A dangerous situation is present, for example, when a dangerous ledge, for the robot 100 difficult terrain (e.g. damp, slippery, strongly inclined or uneven underlying surface) or an obstacle is found to be in the immediate environment of the robot 100 or when an obstacle is found to be moving towards the robot 100 (e.g. people). If no dangerous situation is detected, nothing happens and the safety module 150 continues Step 301 (gathering and processing information).

If the safety module 150 recognizes a dangerous situation, it may first inform the control module 140 thereof (Step 303). It is, however, not absolutely necessary that the control module 140 be informed of the detected dangerous situation. The safety module 150 can also function as a “silent observer” and can assess the dangerous situation without informing the control module 140 thereof. The safety module 150 can also test whether the control module appropriately reacts to the dangerous situation. This means that the safety module 150 can test whether the control module 140 controls the drive module 170 such that the robot 100 moves towards an obstacle (or a dangerous ledge, etc.), thus heightening the danger of the situation, or whether the robot 100 is directed away from the dangerous situation, slowed down or stopped. For this purpose the safety module 150 may first determine, depending on the detected dangerous situation, which movements could generally lead to the robot 100 having an accident (Step 304). A movement that, with a high degree of probability, would probably result in an accident may be assessed to be a “dangerous movement”, whereas movements that would probably not result in an accident may be assessed to be “safe movements”. A dangerous movement, for example, is a movement of the robot 100 directly towards a dangerous ledge or an obstacle. Also such movements that could result in the robot 100 brushing an obstacle and causing it to wobble, fall, tilt or suffer damage from the contact with the obstacle may be assessed as being dangerous.

After having defined what constitutes a safe or dangerous movement, the safety module 150 can test whether the current movement of the robot 100 is a safe or dangerous movement (Step 305). To do so the safety module 150 can test, for example, whether the robot 100 is still moving towards the dangerous situation, whether it might pass by the obstacle, or whether it changes direction and moves away from the dangerous situation. For this purpose the safety module 150 can analyze, for example, the control signals that the control module 140 sends to the drive module 170. Alternatively or additionally, however, the movement of the drive module itself can be directly analyzed (e.g. the position of the wheel, the rate of rotation of the wheels, etc.). If the safety module 150 determines that the robot 100 is not (or no longer) carrying out a dangerous movement, nothing happens and the safety module 150 continues Step 301. If, however, the safety module 150 detects that the robot 100 is carrying out a movement assessed as being dangerous, it can initiate countermeasures (safety measures/Step 306) to avoid the accident or at least mitigate its effects and thereby ensure the safety of the robot 100 and that of the surrounding objects. Such countermeasures may include, for example, overwriting the control commands of the control module 140 with control commands of the safety module 150 or cutting off the power supply (battery) of the drive module 170 of the robot 100. If the drive module 170 is cut off from the power supply, the robot 100 remains standing at its current position. Control commands of the safety module 150 may comprise, for example, a stop signal that also causes the robot 100 to remain standing at its current position. Control signals of the control modules 150 may, however, also carry commands regarding direction and/or speed, for example, and that cause the robot 100, for example, to change its direction and/or speed. Accidents can be avoided, for example, simply by reducing the speed if a moving object crosses the prescribed path of the robot. Thus, for example, in many cases it may suffice for the robot 100 to only slightly alter its direction, or to alter it greatly, without, however, altering its speed. It is also imaginable that the robot 100 will move in the completely opposite direction, meaning, for example, that it completes a turn of 180° or that it moves in reverse. If, however, neither reducing the speed nor changing the direction can avoid the accident (e.g. when the obstacle is already too close), the accident can generally still be reliably avoided by stopping the robot 100 (emergency stop).

If both the control module 140 and the safety module 150 sent control commands to the drive module 170, the control commands of the control module can be, for example, ignored and only the control commands of the safety module 150 will be heeded. In this manner control commands of the control module 140 may be, so to speak, overwritten or overruled. As long as the safety module 150 does not send out any control commands, on the other hand, the control commands of the control module 140 may be heeded. As the safety module 150 is configured to only send out control commands in a situation recognized as being dangerous and, in particular, only if the control module 140 reacts inadequately to the recognized dangerous situation, the control commands from the control module 140 will only be overruled by the safety module 150 in similar dangerous situations.

It is also (optionally) possible for the safety module 150 to inform the control module 140 of the countermeasures (Step 307). The control module 140 can confirm that it has received this information (Sstep 308). One way of confirming this, for example, is for the control module 140 to send commands to the drive module 170 that have been altered to adapt to the recognized dangerous situation. It is, however, also possible for the control module 140 to send a confirmation directly to the safety module 150. Once having received such confirmation, a power supply, for example, previously interrupted by the safety module 150, can be resumed.

If, after a specifiable period of time (e.g. 1 second), no or no valid confirmation is received from the control module 140, the safety module 150 can assume, for example, that the continued safe operation of the robot 100 can no longer be guaranteed. In this case the robot 100 may optionally be completely shut down (Step 309). In cases in which the robot 100 has already been stopped as a countermeasure of the safety module 150, it can be shut down, for example, without moving it further. If countermeasures in the form of control commands were sent out by the safety module 150 that lead to a change in the robot's 100 movement, in absence of a received confirmation the robot 100 can be stopped and shut down. Restarting the robot 100 may only then be possible, for example, if a user actively allows it or after the robot 100 has been serviced by the user or a technician (e.g. by cleaning the sensors).

In accordance with one embodiment of the invention, the control module 140 can send a request to the safety module 150 to nevertheless carry out a movement that has been assessed as being dangerous by the safety module 150 in order to enable a continued operation of the robot 100. The request can be made after the control module 140 has been informed by the safety module 150 of countermeasures in response to a dangerous movement. Alternatively or additionally the request may be made as a precaution, so that the safety module 150 is informed in advance of the planned movement. This can prevent, for example, the planned movement from being interrupted. The safety module 150 can assess this request and in turn inform the control module 140 whether the requested movement will be allowed. In many robots the sensors or the sensor module 120 are only configured for a forward movement of the robot 100, i.e. the measurement is directed in the usual direction of movement and hence towards the area before the robot 100. This means the sensors can only provide very limited information about the area behind the robot 100, or no information at all. Movements of the robot 100 in reverse, for example, can therefore only be judged to be safe over very short distances, e.g. movements in reverse over a distance of less than 5 cm or less than 10 cm. Movements in reverse over longer distances, for example, can therefore not be allowed by the safety module 150. Accessing a base station or leaving a base station at which the robot 100 can recharge its power supply, however, may, for example, make movements in reverse over longer distances necessary. Generally the safety module 150 may assume that the base station was correctly placed by the user to allow for a safe approach to and departure from the base station. If the robot 100 then is required to leave or move towards the base station and this requires a movement in reverse over a longer distance, the control module 140 can send a corresponding request to the safety module 150. The safety module 150 can then test, for example, whether the robot 100 is actually located at the base station. To this end, for example, it can test whether a voltage has been applied to the corresponding charging contacts of the robot 100. Another possibility consists, for example, in closing a contact switch when the base station is docked into. In this case the safety module 150 can test whether the contact switch is closed. These are, however, merely examples. Any other suitable means for verifying whether the robot 100 is at a docking station may also be used. Once the safety module 150 has detected that the robot 100 is located at a base station, it can allow the movement in reverse over the distance needed to leave the base station, even if the needed distance is greater than the distance generally allowed for movement in reverse. If, however, the safety module 150 detects that the robot 100 is not located at a base station, only the generally allowed distance for movement in reverse can be permitted. This, however, is only an example. There are various other imaginable situations in which the safety module 150 might, by way of exception, judge a movement assessed as being dangerous to be safe and allow it to be carried out.

In accordance with a further embodiment of the invention, the safety module is configured to carry out a self-test. This self-test may comprise, for example, a read and write test of the memory module that belongs to the safety module 150. If this self-test fails, the robot 100 can be stopped and completely shut down until a user allows it to be further operated. If a self-test fails, the continued safe operation of the robot 100 can generally no longer be guaranteed. Self-testing can also be achieved, for example, by means of a redundant layout of various components. To this end, for example, a duplicate processor and/or memory module of the safety module 150 may be provided, in which case a danger detection software can be run on both existing processors. As long as the findings of both processors are identical or at least exhibit only minor tolerable deviations, it may be assumed that the safety module 150 is functioning properly.

In accordance with a further embodiment of the invention the safety module 150 can be configured to monitor the reliable operation of the sensors of the sensor module 120. For this purpose it may suffice to only monitor those sensors that provide information to the safety module 150. By monitoring the sensors it can be determined, for example, whether a sensor is providing incorrect or unreliable data due to being, for example, defective or dirty. The monitored sensors may also be configured to recognize functional defects autonomously and to report these to the safety module 150. Alternatively or additionally the sensors may be configured to only provide the safety module 150 with sensible measurement data as long as the sensor is fully functional. Thus, for example, a floor clearance sensor cannot be considered to be functioning properly if it constantly indicates a distance to the underlying surface of zero (or infinite) instead of a value that is typical for the distance of the sensor to the floor. Alternatively or additionally, the safety module 150 can also test the consistency of the data received from the sensors. For example, the safety module 150 can test whether the sensor data used to determine the movement of the robot 100 is consistent with the control commands sent out by the control module 140. If one or more faulty sensor signals are detected, the robot can be stopped and completely shut down until the user allows it to be further operated as, in such a case, a safe operation of the robot 100 can no longer be guaranteed.

Dangerous movements can be determined by the safety module 150 based on direct sensor measurements. Direct sensor measurements are measurements, for example, that are carried out by a floor clearance sensor. It is, however, also possible to determine dangerous movements on the basis of interpreted sensor measurements. Sensor measurements that are interpreted, for example, may entail the recognition of objects on pictures taken by a camera on the robot 100 by means of image analysis. The robot 100 may be configured, for example, to recognize markings or persons and their movements in the environment of the robot 100. Markings may include, for example, warning signs that have been put up to warn of freshly washed and thus slippery floors. A similar warning sign, which is usually placed on the floor, can be recognized as such, for example, thanks to its shape. However, it is also possible to recognize the writing on the sign (e.g. Caution—Slippery floor) or a marking on the warning sign, e.g. a QR (Quick Response) code. Information regarding recognized markings can be sent to the safety module 150, which can assess the situation based on this information and, if necessary, correspondingly adapt the criteria applied in assessing the movement of the robot. For example, the safety module 150, having detected a slippery floor, can reduce the maximum speed of the robot 100 that is judged to be safe.

In Step 304, instead of dangerous movements, safe movements may also be determined. In Step 305 the safety module 150 can then test to determine whether the robot 100 is carrying out one such safe movement. Countermeasures can be initiated in those cases in which the robot 100 is determined to be carrying out a movement that does not correspond to any of those identified as being safe.

In general, any known dangerous situation can be detected using the method described here. The known dangerous situations can be specifically simulated in tests in order to verify the safety of the robot 100. To carry out such a test, for example, the robot 100 may be intentionally placed in a potentially dangerous situation (e.g. by positioning the robot next to a dangerous ledge). Then a case can be simulated in which the control module 140 sends false and/or erratic control commands to the drive module 170. Subsequently the safety module 150 can be observed to see whether it can reliably prevent an accident.

FIG. 4 shows, as an example, a plan view of the underside of an autonomous mobile robot 100. FIG. 4, in this case, shows a cleaning robot, whereas the cleaning module of the robot has been omitted in the illustration for clarity. The illustrated robot 100 has two drive wheels 171 and a front wheel 172 that belong to the drive module 170. The front wheel 172 may be, for example, a passive wheel that does not have a drive of its own and is only moved by the movement of the robot 100 across the floor. The front wheel 172 may be rotatable by 360° around an axis that runs essentially perpendicular to the floor (the direction of rotation is indicated in FIG. 4 by a dashed arrow). Each of the drive wheels 171 can be connected to an electric drive (e.g. electromotor). The robot 100 is moved forward by the rotation of the drive wheels 171. The robot 100 also has floor clearance sensors 121. In the example illustrated in FIG. 4 the robot 100 has three floor clearance sensors 121R, 121M, 121L. A first floor clearance sensor 121R is arranged, for example, on the right side of the robot 100 (as seen in the direction of movement), whereas the first floor clearance sensor 121R need not be arranged on the middle axis x that divides the robot 100 into a front segment and a back segment of equal size. Instead the first floor clearance sensor 121R can be arranged, for example, slightly towards the front as seen from the middle axis x. A second floor clearance sensor 121L is arranged, for example, on the left side of the robot 100 (as seen in the direction of movement) and the second floor clearance sensor 121L also need not be arranged on the middle axis x. The second floor clearance sensor 121L can also be arranged slightly towards the front as seen from the middle axis x. A third floor clearance sensor 121M can be arranged, for example, centered at the front of the robot 100. Thus, for example, at least one floor clearance sensor 121 is arranged before every wheel to detect a dangerous ledge while moving forward and before the wheel moves over it.

The floor clearance sensors 121 are configured to detect the distance of the robot 100 to the underlying surface, or they are at least configured to detect whether a floor surface is present at a given distance. During normal operation of the robot 100 the floor clearance sensors 121 generally produce relatively consistent values, as the distance of the floor clearance sensors 121, and that of the robot 100, to the underlying surface changes only a little. In particular in the case of smooth floors, the distance to the underlying surface remains mostly the same. Small deviations in the values may be caused, for example, by carpets that the drive wheels 171 and the front wheel 172 could sink into. This may reduce the distance of the robot body and therewith that of the floor clearance sensors 121 to the underlying surface. Dangerous ledges such as, for example, stair steps can be recognized when, for example, the values produced by at least one of the floor clearance sensors 121 suddenly greatly increase. For example, a dangerous ledge can be recognized if the measured value of at least one floor clearance sensor 121 rises above a specified threshold. The floor clearance sensors 121 may have, for example, a transmitter for an optical or acoustic signal and a receiver that is configured to detect the reflection of the emitted signal. Possible measurement methods include measuring the intensity of the signal reflected off the floor, triangulation or measuring the travel time of the emitted signal and its reflection. In accordance with one embodiment of the invention, the floor clearance sensor 121 does not determine, for example, the exact distance of the sensor to the underlying surface, but instead only provides a Boolean signal that indicates whether the underlying surface has been detected within a specified distance (e.g. the underlying surface is detected within a distance of, e.g. maximum 5 cm from the sensor 121).

The typical movements carried out by an autonomous mobile robot include forward movement, turning to the right or the left and combinations of these movements. If the robot 100 moves towards a dangerous ledge while carrying out one of these movements, this will be detected by at least one of the floor clearance sensors 121. By applying simple geometric considerations those movements that might lead to an accident (in this case to a fall) of the robot 100 can be determined. If, for example, one or more of the floor clearance sensors 121R, 121L arranged on the side of the robot 100 is triggered, then the robot 100 is only allowed to move forward over a maximum first distance L1, whereas the first distance L1 corresponds to the distance between the corresponding drive wheel 171 (wheel jacking point) and the floor clearance sensor 121R, 121L. If, for example, the third floor clearance sensor 121M that is arranged at the front of the robot 100 is triggered, then the robot 100 can only be allowed to move forward over a second distance L2, whereas the second distance corresponds to the distance between the front wheel 172 (wheel jacking point) and the third floor clearance sensor 121M. Hence the robot 100 must be capable, while moving at full speed, of detecting a dangerous ledge, of generating a control signal to apply the brakes and of coming to a full stop before reaching the dangerous ledge (that is, within the first or second distance L1, L2). To achieve this, in particular the reaction time of the individual required components should be taken into consideration, meaning, for example, that of the sensor module 120, the control module 140, the safety module 150 and that of the drive module 170, as well as the speed of the robot 100, the possible (negative) acceleration needed to bring the robot 100 to a stop and the resulting braking distance. For example, the safety module 150 can be configured to only allow the robot 100 to move in reverse when at least one of the floor clearance sensors 121 has been triggered. A floor clearance sensor is triggered when it is detected that the distance to the floor is greater than an allowed maximum value.

In the example illustrated in FIG. 4 the second distance L2 is shorter than the first distance L1. In order to nevertheless be completely sure that the robot 100 will be stopped in time before reaching a dangerous ledge after the third floor clearance sensor 121M has been triggered, the safety module 150 can be configured, for example, to send out a control signal to stop the robot 100 immediately as soon as the third floor clearance sensor 121M is triggered. In this case the safety module 150, for example, cannot first verify whether the control module 140 exhibits the correct behavior as this would demand too much time. Only after first stopping the robot 100 can the safety module 150 test, for example, whether the control module 140 also sends control commands to the drive module 170 that are appropriate for the detected situation. Appropriate control commands in such a situation can include, for example, commands for the robot to stop, to move in reverse or to turn away from the dangerous ledge. If the safety module 150 recognizes that the control module 140 is sending out appropriate control signals, it can completely relinquish control of the robot 100 to the control module 140 or return the control to it. If, however, the safety module 150 recognizes that the control module 140 is sending control commands to carry out a dangerous movement (e.g. moving forward), it can maintain or assume control of the robot. As mentioned previously, the safety module 150 will still be capable, for example, of sending out the command to stop the robot 100, of cutting off the power supply of the drive module 170 or of sending out control commands that overrule the control commands of the control module 140 (e.g. to move in reverse) and that ensure the safe operation of the robot 100.

If the first or the second floor distance sensor 121R, 121L is triggered it may suffice, for example, to await a reaction of the control module 140 to the dangerous situation, as there is more time available for the robot 100 to come to a complete stop in order to avoid an accident. In such a case the safety module 150 can wait, for example, until the robot 100 has covered a third distance L3 (e.g. wherein L3=L1−L2). At this point in time the robot 100 then has only the time available that is needed for the second distance L2 to avoid an accident. Hence, during the time needed for the 3^{rd} distance L3 the safety module 150 can allow the control module 140 to act on its own and need not override its control commands or stop the robot 100. If the control module 140 reacts adequately during this period of time, the safety module 150 need not intervene and it remains passive. Whether or not the third distance L3 has already been travelled can be determined, for example, based on the possible maximum speed of the robot 100 and on the amount of time that has elapsed or with the aid of odometers. The safety module 150 can stop the robot 100, for example, if the control module 140 does not stop the robot 100 and/or direct it away from the dangerous ledge within 10 ms after detection of the dangerous ledge by the first or second floor clearance sensor 121R, 121L.

To save costs, robots 100, as illustrated in FIG. 4, often have only one floor clearance sensor 121 at the front of the robot 100 and thus dangerous ledges can only be detected when the robot 100 is moving forward. As the robot 100 generally only move in a forward direction, this is usually enough to ensure the safe operation of the robot 100 with regard to dangerous ledges. In some cases, however, movement in a forward direction may be blocked by obstacles or dangerous ledges. In such cases it may be unavoidable for the entire robot 100, or at least one of its drive wheels 171, to move in reverse in order to extract itself from the situation. When doing so the robot 100, however, can only move as far in reverse as the extent to which the path in this direction is known to it. If it does not know the path, the risk of it having an accident arises as, due to the lack of floor clearance sensors at the back of the robot 100, it cannot, for example, recognize dangerous ledges located behind it. The most recent distance covered by the robot 100 can be approximated as a straight line, for example. Moving in reverse may be assessed as safe for a fourth distance D, wherein D is the distance between the drive wheels 171 and the perimeter S on which the floor clearance sensors at the front of the robot 100 are arranged. If the most recent forward movement of the robot covered a shorter distance than the fourth distance D, it may be allowed to move in reverse over a distance that is not longer than the most recent distance travelled while moving forward. In the case of combined forward and backward movements the distance that has actually been travelled can be determined and taken into consideration for a possible movement in reverse.

The safety module 150 may be configured, for example, to not allow any reverse movement of the robot 100 immediately after it has been turned on, as it is possible that it does not yet possess any information regarding its environment and does not know whether or not there is a dangerous ledge behind it. For example, perhaps the robot 100 has been placed by a user on a table near the edge of the table or on a stair step or a stair landing. In such cases the safety module 150 can also block a reverse movement of the robot 100 if its forward movement is blocked by an obstacle or a dangerous ledge. As described further above, when the control module 140 wants to direct the robot 100 to leave a base station in reverse, it can send a corresponding request to the safety module 150. If, after having received such a request, the safety module 150 verifies that the robot 100 is indeed located at a base station, it can then allow a movement in reverse over the distance needed to leave the base station.

The movement of the robot 100 can be determined with the aid of a wide range of different sensors, for example, by means of odometers (e.g. wheel encoders) and/or calculated based on the control commands generated by the control module 140 and recorded by the safety module 150. When doing so the path covered by the robot 100 in a previously specified time interval and/or movement interval can be saved, for example. In addition to this, for example, the position or path of the floor clearance sensors 121 can also be saved in order to be able to better assess the safety of a surface.

In accordance with one embodiment of the invention, the perimeter S on which the floor clearance sensors 121 are arranged may be assessed to be a safely accessible surface if the robot 100 has previously moved forward over a distance that is at least larger than the radius of the perimeter S. In this case the safety module 150 can be configured to stop the robot 100 if it detects (e.g. on the basis of the control commands and/or an odometer) that the robot 100, while moving in reverse (and in combination with short movements forwards), leaves the perimeter S as a result of a backwards directed movement.

In order to avoid collisions, numerous sensors for detecting obstacles may be used together. For example, the sensor module 120 may have optical sensors (e.g. laser scanners) that are configured to detect obstacles without coming into contact with them. The sensor module 120, however, may also have tactile sensors that are configured to detect obstacles upon contact that are not easily detected optically (e.g. glass doors). A tactile sensor, for example, may comprise a contact switch that is configured to close when an obstacle is touched. A tactile sensor may also have, for example, a spring deflection that allows the robot 100 to decelerate before the main body of the robot 100 collides against the obstacle. In such a case the safety module 150 behaves analogously to the case in which a floor clearance sensor 121 is triggered upon detection of a dangerous ledge.

The safety module 150 may be configured, for example, to monitor obstacles in the vicinity of the robot. If obstacles are detected within a specified distance from the robot 100 the safety module 150, for example, can prevent movement at a speed above a given speed limit. The specified distance may be dependent on the direction in which the obstacle is detected. For example, an obstacle detected behind the robot 100 does not, as a rule, limit the forward movement of the robot 100. The speed limit may depend on the distance to the obstacle and/or the direction in which the obstacle was detected.

The sensor module 120 may also have sensors, for example, that are configured to detect living things, in particular people or house pets, and their movements. For this purpose the sensors may comprise, for example, a camera that is configured to take pictures of the environment. For example, people or animals can be recognized using face recognition methods and/or based on the emission of infrared rays (resulting from the body heat of people and/or animals) and further based on the pictures taken of people and/or animals. When doing so the position of an object at a given point in time or at numerous subsequent points in time can also be determined. It can be thereby determined whether the object is moving and, if so, at what speed. Based on the current speed at which the object is moving a possible position of the object at a future point in time can be determined. Based on this information then the safety module 150 can determine whether the object and/or the robot 100 is in danger and can prevent the robot 100 from moving towards the determined future position of the object.

The safety module 150 may also be configured to prevent movement at speeds and/or rates of acceleration that exceed a specified threshold when an object has been detected regardless of the speed or direction of the moving object. Limiting the maximum allowed speed increases, for example, the amount of time available for the robot 100 to react to unexpected movements of the object. At the same time, limiting the maximum allowed speed reduces the risk of harming people or pets, as well as that of damaging the robot or other objects, as reducing the speed of the robot 100 results in a reduction of its kinetic energy. Reducing the robot's 100 rate of acceleration also makes it easier for people in its environment to predict the behavior of the robot 100 and enables them to react better to the robot's behavior, thus also reducing the risk of accidents.

A sensor module 120 of an autonomous mobile robot 100, for example, a transport robot, can comprise, for example, sensors that are configured to detect whether, and if so what objects (e.g. glasses or plates) the robot 100 is transporting. Based on these findings, the behavior of the robot 100 can be adapted. For example, a robot 100 can accelerate faster and move at a greater speed when it is not transporting anything. If it is transporting, for example, flat objects such as plates, as a rule it will be able to accelerate faster than when it transports glasses or bottles.

As opposed to the robot illustrated in FIGS. 1A, 1B and 4, an autonomous mobile robot 100, e.g. a telepresence robot may also have a tall slim construction design (cf. FIGS. 1C and D). Due to this construction design, however, the robot 100 may be susceptible to tipping movements. Decisive for the stability of such a robot 100 is the position of its center of gravity, its points of contact to the floor surface and the forces and torques impacting the robot 100. The points of contact, for example, are the drive wheels of the drive module 170. The forces and torques are caused, for example, by gravitational force, by forces that arise when the robot 100 accelerates over an even or sloped surface, by outside forces that impact the robot 100 such as jolts, as well as by the position of the robot on an even or sloping surface. Methods for analyzing the conditions influencing the stability of the robot's 100 position are generally known and will not be discussed further here.

Whether or not the current position of the robot 100 is stable can be determined by measuring the current acceleration rate and angular velocity with an IMU (Inertial Measurement Unit) at at least one point on the robot 100. The IMU may be arranged, for example, near the center of gravity of the robot. Further, the position of the robot 100 can be determined, that is, for example, whether the robot 100 is located on an even or inclined surface. A robot 100 located on an inclined surface will, as a rule, be more prone to falling over (loss of stability of the robot's 100 position, cf. FIGS. 1C and D). The location of the robot's 100 center of gravity can also be determined. For example, in telepresence robots the height of the multimedia unit 101 arranged at the upper end may be varied to adapt to the user's needs (e.g. whether the user sits or stands). This changes the location of the robot's center of gravity, which in turn changes the dynamics and positional stability of the robot 100.

The safety module 150 can be configured to ensure that the control module 140 does not send any control commands to the drive module 170 that endanger the stability of the robot 100. To this end the safety module 150 can be configured, for example, to determine what forces and torques might impact the robot 100 as a result of the control commands sent out by the control module 140 and whether they are compatible with the robot's 100 stability. If the safety module 150 identifies a control command that could endanger the stability of the robot's 100 position, it can, for example, initiate countermeasures (safety measures). Countermeasures may comprise, for example, stopping the robot 100. In addition, the control module 140 can be informed of the countermeasures. One example of a control command that could endanger the stability of the robot's 100 position would be for the robot 100 to accelerate too quickly, as this might lead to the robot 100 tilting. It is relatively easy to determine the maximum allowable acceleration rates based on an analysis of the robot's stability. The maximum allowable acceleration rates, for example, depend on a position of the robot 100 (inclination), the direction of the acceleration relative to the position of the jacking points (acceleration forwards, braking, movement along an arc, etc.) and on the robot's center of gravity. Hence, for example, a robot 100 can accelerate faster on a ramp while heading downwards than it can while heading upwards. Having a low center of gravity will generally allow the robot 100 to accelerate faster than when it has a high center of gravity. A further example of a movement that may be prevented by the safety module 150 is movement along a steeply inclined ramp. The safety module 150 may prohibit the robot 100 from moving further if the robot tilts at above a specified angle relative to the horizontal. This allowed angle of inclination may depend on the height of the robot's center of gravity.

Situations may also arise, however, in which the robot 100 unanticipatedly enters an instable position and tilts. For example, the robot might remain standing in order to allow a person to pass by and in the course of this may receive a jolt. An automatic movement of the robot 100 to counter the jolt may prevent the robot 100 from falling over. The safety module 150 may be configured, for example, to recognize such a jolt based on a measurement of acceleration and position and can test whether the control module 140 sends out a control command is adequately adapted to counter the jolt. Control commands such as “do nothing” or “stop”, for example, could be judged to be dangerous in such a situation as it is generally necessary for the robot 100 to move in order to counter the jolt and stabilize itself. The safety module 150 may be configured to detect, for example, when waiting for the reaction of the control module 140 would take up too much time and, without waiting for the reaction of the control module 140, can send control commands to the drive module 170 that bring about a movement of the robot 100 to counter the jolt. If the safety module 150 recognizes that the control module 140 does not react at all to the jolt, or reacts inadequately, it can send control commands to the drive module 170 to carry out a movement that is adapted to counter the jolt.

The safety module 150 may be further configured to monitor a function of the work module 160. This may be particularly advantageous when the operation carried out by the work module 160 involves a more expansive movement of the work module 160 itself and/or a movement of the robot 100 by the drive module 170.

The work module 160 may have, for example, a brush for gathering dirt. One danger that this might bring about is that laces of shoes lying nearby, the fringe of carpets or cords of electric devices could become raveled around the rotating brush and block it. The rotation of the brush can be measured, for example, using a speed encoder. It can thereby be determined that a brush is blocked when it is detected that the brush is no longer rotating. It is also possible, for example, to determine the electrical power consumption of the brush motor and to detect a block brush on that basis.

Various methods are known for releasing a blocked brush. For example, the control module 140 can let the brush idle while it moves the robot 100 in reverse, letting the cable or similar object unravel. This procedure, however, poses some risks. Movements of robots 100 with blocked brushes are always capable of leading to accidents. If, for example, the object tangled in the brush is an electric cable, the danger will always exist of the robot dragging the electric device along with itself as it moves in reverse. If the electric device is located in an elevated place, for example, on a shelf, this could result in it falling to the floor and being damaged. The safety module 150 can therefore, for example, be configured to detect whether the brush is still blocked when a procedure for releasing the brush is carried out. If that is the case, the movement of the robot 100 can be stopped, as it is no longer possible for the robot to move either forwards or in reverse without damaging objects. Another possibility is to rotate the brush in the direction opposite to its normal direction of rotation to liberate the brush from the cable or similar object without the robot 100 changing its position.

1. Autonomous mobile robot (100) with:
a drive module (170), configured to move the robot (100) through an environment;
a control module (140) configured to sent control commands to the drive module (170), wherein the control commands are configured to control the movement of the robot (100); and
a safety module (150) configured to;
detect a dangerous situation by assessing a current movement of the robot (100) controlled by the control module (140) to be dangerous based on specified criteria; and
alter or stop the movement of the robot (100) if the current movement is assessed as being dangerous.

2. Robot (100) in accordance with claim 1, wherein the safety module (150) is further configured to:
monitor the behavior of the robot (100) that is determined by the control module (140) in a situation that has been recognized by the safety module (150) as a dangerous situation, and
assess this behavior as adequate or inadequate in accordance with specified criteria.

3. Robot (100) in accordance with claim 2, wherein the monitoring the reaction of the control module (140) comprises analyzing the control commands sent by the control module (140), wherein inferences can be drawn from the control commands regarding the current movement of the robot (100).

4. Robot (100) in accordance with any of claim 2 or 3, wherein the monitoring of the reaction of the control module (140) comprises receiving information from the drive module (170), the information comprising at least one of
control commands sent to the drive module (170), and
a current movement of the drive module (170).

5. Robot (100) in accordance with any of claims 2 to 4, wherein the safety module (150) is configured to only alter or stop the movement of the robot (100) if the movement is assessed as dangerous and the reaction of the control module (140) is assessed as inadequate.

6. Robot (100) in accordance with any of claims 1 to 5, wherein the robot (100) further comprises a sensor module (120) that is configured to provide information regarding at least one of
an internal state of the robot (100), and
the environment of the robot (100).

7. Robot (100) in accordance with claim 6, wherein the safety module (150) is further configured to monitor the operation of the sensor module (120) and to stop the robot (100) if the operation of the sensor module (120) is recognized as being defective.

8. Robot (100) in accordance with claim 6 or 7, wherein the sensor module (120) has at least one floor clearance sensor (121) configured to detect a dangerous ledge on the floor.

9. Robot (100) in accordance with claim 8, wherein, for detection of a dangerous ledge, the at least one floor clearance sensor (121) is configured to determine whether a distance between the robot (100) and the floor beneath the robot (100) exceeds a maximum value or to measure a distance between the robot (100) and the floor beneath the robot (100).

10. Robot (100) in accordance with claim 8 or 9, wherein the safety module (150) is configured to detect, based on the information provided by the at least one floor clearance sensor (121), a dangerous situation and/or wherein the safety module (150) is configured to assess, based on the information provided by the at least one floor clearance sensor (121), the current movement of the robot (100) as inadequate.

11. Robot (100) in accordance with any of claims 6 to 10, wherein the sensor module (120) comprises at least one of
an optical sensor for contactless detection of obstacles,
a tactile sensor for contact detection of obstacles,
a camera for taking pictures of the environment,
an acceleration sensor,
a rotation rate sensor,
an odometer,
a current sensor,
a wheel contact switch, and
a laser sensor.

12. Robot (100) in accordance with any of claims 6 toll, wherein the sensor module (120) comprises at least one inertial measurement unit that is configured to detect at least one of
an acceleration, and
an angular velocity of the inertial measurement unit

13. Robot (100) in accordance with claim 12, wherein the safety module (150) is configured to
determine a stability of the robot (100) based on the acceleration or the angular velocity of the inertial measurement unit and to assess it as endangered or not endangered, and
to alter or stop the movement of the robot (100) if the stability of the robot (100) is assessed as endangered.

14. Robot (100) in accordance with any of claims 1 to 13, wherein the robot (100) is configured to move through the environment using a map of the environment, wherein the map contains information about obstacles in the environment.

15. Robot (100) in accordance with any of claims 6 to 14, wherein the safety module (150) is further configured to detect a dangerous situation based at least on one of
the information provided by the sensor module (120), and
with reference to claim 14, the information contained in the map of the environment.

16. Robot (100) in accordance with any of claims 1 to 15, wherein the safety module (150) is configured to inform the control module (140) when the safety module (150) alters or stops a movement of the robot (100).

17. Robot (100) in accordance with any of claims 1 to 16, wherein altering or stopping a movement of the robot (100) by the safety module (150) comprises overwriting or overruling the control commands sent by the control module (140) to the drive module (170).

18. Robot (100) in accordance with any of claims 1 to 17, wherein the robot (100) has an internal power supply that is configured to provide power to the drive module (170) and wherein the altering or stopping of a movement of the robot (100) comprises cutting the drive module (170) off from the internal power supply.

19. Robot (100) in accordance with any of claims 1 to 18, wherein the drive module (170) comprises at least two drive wheels (171) that are configure to be connected to an electric drive and to move the robot (100) through the environment.

20. Robot (100) in accordance with any of claims 1 to 19, wherein the safety module (150) is configured to
detect obstacles in the environment of the robot (100), and
reduce a maximum allowed speed of the robot (100) if an obstacle is detected in the environment of the robot (100).

21. Robot (100) in accordance with any of the preceding claims, wherein the robot (100) further comprises a work module (160) that is configured to treat a floor surface.

22. Robot (100) in accordance with any of claims 1 to 20, wherein the robot (100) has a transport platform (104) or a gripper arm for transporting objects.

23. Robot (100) in accordance with any of the preceding claims, further having a communication module (130) that is configured to establish a communication connection to at least one of
a Human Machine Interface (200), and
an external device (300).

24. Robot (100) in accordance with claim 23,
wherein the control module (140) is configured to generate, based on data received via the communication connection, control commands for the drive module (170).

25. Robot (100) in accordance with claim 23 or 24, wherein the communication connection comprises at least one of
a direct wireless connection,
a local wireless network connection, and
an Internet connection.

26. Robot (100) in accordance with any of the preceding claims,
wherein the control module (140) has a processor that is configured to execute a control software, and
wherein the safety module (150) has a further separate processor that is configured to execute a software for the recognition of dangerous situations.

27. Method for controlling an autonomous mobile robot (100), the method comprising:
controlling a movement of the robot (100) by a control module (140), wherein the controlling of the movement comprises the sending of control commands from the control module (140) to a drive module (170), wherein the drive module (170) is configured to move the robot (100) through an environment,
detecting a dangerous situation by means of a safety module (150);
assessing a current movement of the robot (100) as dangerous based on specified criteria when a dangerous situation has been detected; and
altering or stopping a movement of the robot (100) by the safety module (150) if the movement is assessed as dangerous.

28. Method in accordance with claim 27, further comprising:
monitoring a reaction of the control module (140) to a detected dangerous situation, and
assessing the reaction of the control module (140) as adequate or inadequate based on specified criteria.

29. Method in accordance with claim 28, further comprising:
only altering or stopping the movement of the robot (100) if the movement has been assessed as dangerous and the reaction of the control module (140) is assessed as inadequate.

30. Method in accordance with any of claims 27 to 29, further comprising:
informing the control module (140) when the safety module (150) has detected a dangerous situation.

31. Method in accordance with any of claims 27 to 30, further comprising:
informing the control module (140) when the safety module (150) alters or stops a movement of the robot (100).
